(19) United States
(12) Patent Application Publication
(10) Pub. No.: US 2023/0372886 A1
(43) Pub. Date: Nov. 23, 2023

(54) Systems, Methods and Apparatuses to Make Nail Polish

(71) Applicant: Preemadonna Inc., New York, NY (US)

(72) Inventors: Herpreet Walia, Carlsbad, CA (US); Marie Millan, Folsom, CA (US)

(21) Appl. No.: 18/129,906

(22) Filed: Apr. 3, 2023

Related U.S. Application Data
(60) Provisional application No. 63/326,294, filed on Apr. 1, 2022.
(60) Provisional application No. 63/402,978, filed on Sep. 1, 2022.

(51) Int. Cl. B01F 35/71; B01F 35/22; B01F 29/30

(52) U.S. Cl. CPC B01F 35/717611; B01F 35/2207; B01F 29/30; B01F 2101/30

(57) ABSTRACT

Systems, methods and apparatuses to make nail polish are disclosed. In one aspect, embodiments of the present disclosure include an apparatus, which may be implemented on a system, to make nail polish from one or more ink colors. The apparatus can include an ink retention unit configured to hold or store one or more ink storage containers and/or an ink deposit component and mechanically coupled to the ink retention unit. In one embodiment, the ink deposit component includes an actuator to control or regulate ink that is released from the ink retention unit. In addition, a nail polish holder area under the ink deposit component can be configured to receive the ink released from the ink deposit component

### CLAIM OF PRIORITY

This application claims the benefit of:

U.S. Provisional Application No. 63/326,294, filed Apr. 1, 2022 and entitled “APPARATUSES, SYSTEMS AND METHODS FOR AN AUTOMATED NAIL POLISH MAKER” (8008.US00); and

U.S. Provisional Application No. 63/402,978, filed Sep. 1, 2022 and entitled “APPARATUSES, SYSTEMS AND METHODS FOR AN AUTOMATED NAIL POLISH MACHINE” (8008.US01);

the contents of which are incorporated by reference in their entireties.

### TECHNICAL FIELD

The disclosed technology relates generally to systems, methods and apparatuses for creating or mixing nail polish through an automatic or semi-automatic process.

### BACKGROUND

In the cosmetics industry, most consumers buy pre-packaged and static color polishes and other makeup products from brands and retailers. For instance, most nail polish is manufactured and bottled by larger production facilities with high minimum order quantities which limits the number of color variations brands and retailers can sell to consumers. There is also a minimum volume of nail polish that each bottle must contain for economic feasibility to the manufacturer. As a result, end consumers end up purchasing more nail polish than needed or used resulting in unnecessary waste with detrimental environmental impacts.

### BRIEF DESCRIPTION OF THE DRAWINGS

FIG. 1 depicts a view of an example apparatus to make nail polish, in accordance with embodiments of the present disclosure.

FIG. 2A-2E depict multiple views of an example ink retention area of the apparatus to make nail polish, in accordance with embodiments of the present disclosure.

FIG. 3A-3D depict multiple views of an ink deposition area of the apparatus to make nail polish, in accordance with embodiments of the present disclosure.

FIG. 4A-4F depict multiple views of a nail polish mixing area of the apparatus to make nail polish, in accordance with embodiments of the present disclosure.

FIG. 5A depict s multiple views of a user interface area of the apparatus to make nail polish, in accordance with embodiments of the present disclosure.

FIG. 5B depict s a diagram illustrating examples of various interactions accessible from the user interface area, in accordance with embodiments of the present disclosure.

FIG. 6A-6B depict multiple views of a housing of the apparatus to make nail polish, in accordance with embodiments of the present disclosure.

FIG. 7A-7C depict multiple views of a power and electronics area of the apparatus to make nail polish, in accordance with embodiments of the present disclosure.

FIG. 8 graphically depict example user interfaces for making nail polish, in accordance with embodiments of the present disclosure.

FIG. 9A depicts an example functional block diagram of a system or apparatus that can make or mix nail polish, in accordance with embodiments of the present disclosure.

FIG. 9B depicts a flow chart illustrating example processes of the apparatus to make or mix nail polish, in accordance with embodiments of the present disclosure.

FIG. 10 depicts an example functional block diagrams of a system or apparatus that facilitates nail polish making or mixing, in accordance with embodiments of the present disclosure.

FIG. 11 depicts another example of functional block diagrams of a system that facilitates nail polish making, in accordance with embodiments of the present disclosure.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure describe and illustrate systems, methods and apparatuses for creating, making or mixing nail polish.

The ability to customize and create your own nail polish quickly, affordably, and conveniently does not exist. Most consumers buy pre-packaged and static color polishes from brands and retailers. Most nail polish is manufactured and bottled by larger production facilities with high minimum order quantities which limits the number of color possibilities brands and retailers introduce to consumers. This innovation—an automated nail polish maker—allows users to create their own nail polish color in the comfort of their own home, favorite small business/salon or even retailer. Users and their favorite small businesses thereby become consumer nail polish factories in the comfort of their own home from this innovation

According to embodiments of the present disclosure, the nail polish created can have a predetermined color or have a customized color of any shade or hue. The disclosed technology provides a consumer with easy control to choose any shade of polish and then automatically create it via a nail polish maker and/or mixer via an automated/semi-automated process. There is also less waste of nail polish material and bottles as a user can control how much polish they want to create and reuse the nail polish bottle.

As a significant portion of the audience for nail polish cosmetics are young people—there is an opportunity to incorporate science, technology, engineering, and math elements into the consumer use of the beauty innovation to make it a playful learning experience. For example, some embodiments of the disclosed device enables for a user to make, code and program, and/or connect modular components of the automated nail polish maker allowing for an interactive educational experience.

The disclosed system, apparatus and the methods described herein are applicable to any colored cosmetics, makeup product, or make up ingredient, including but not limited to blush and eyeshadow according to embodiments of the present disclosure. In general, the disclosed apparatus or system is able to make nail polish from any number of ink colors (e.g., one ink color or multiple ink colors).

In one embodiment, the apparatus to make nail polish from one or more ink colors. The apparatus can include a housing unit, and an ink retention unit configured to hold or store one or more ink storage containers. For instance the one or more ink storage containers can be used store each of the one or more ink colors separately. In general, the ink retention component is formed in the housing unit of the apparatus.

In one embodiment, the one or more ink storage containers has formed thereon, an opening for refill of its contents (e.g., ink). In this embodiment, the one or more ink storage containers can be attached to the ink retention component and irremovable from the ink retention component or the housing unit. For example, the housing unit can include a hinge system which is mechanically couples or attaches the one or more ink storage containers to the housing unit. The hinge system can therefore be operable by rotation to access the one or more ink storage containers for refill or removal.

In one embodiment, the one or more ink storage containers are rotated onto or screwed into the ink retention unit. The apparatus can further include an ink deposit component disposed in the housing unit and the ink deposit component can be mechanically coupled to the ink retention unit.

The ink deposit component can for example, include an actuator to control or regulate ink that is released from the ink retention unit. In one embodiment, the actuator includes a peristaltic pump system. The peristaltic pump system can have multiple peristaltic pumps where each peristaltic pump is mechanically coupled to and to control each of the one or more ink storage containers. The peristaltic pump system can also have one or more motors mechanically coupled to the peristaltic pump system. The one or more motors are, for example, operable to rotate each of the multiple peristaltic pumps.

The ink deposit component can also include a funnel adapted to direct ink flow to the nail polish holder area. Additionally, the apparatus can include a nail polish holder area under the ink deposit component configured to receive the ink released from the ink deposit component. The ink deposit component can also include a funnel adapted to direct ink flow to the nail polish holder area.

One embodiment of the apparatus further includes a nail polish holder device arranged to hold or receive a nail polish bottle to receive and store the ink released to the nail polish holder area. The nail polish holder device can be mechanically coupled to the housing unit in a mixing area. For example, the nail polish holder device can be mechanically coupled to the mixing area through a ball joint. The ball joint enables tilting of the nail polish holder device and the nail polish bottle.

The nail polish holder device can be configured to tilt the nail polish bottle. For example, the nail polish holder device can include a spring clamp to hold the nail polish bottle in a tilted position. In addition, the nail polish holder device can be mechanically coupled to the mixing area through a motor operable to rotate the nail polish holder device. In one embodiment, the mixing area forms a portion of the housing unit and is co-located with the portion of the housing unit having the nail polish holder area.

In a further embodiment, the mixing area forms a second portion of the housing unit where the second portion of the housing unit is distinct from the portion of the portion of the housing unit having the nail polish holder area. In another embodiment, the mixing area is a physical component distinct from the housing unit and the nail polish holder area of the housing unit. In this example, the mixing area is operably coupled to the housing unit via a connection unit/connection point.

The apparatus can also include a power component formed in the housing unit. In one embodiment, a display (e.g., user interface component or user interface area) is coupled to the power component. The display can be integrated into the housing unit and formed on a visible surface of the housing unit. The display can in some instances include a touch screen.

The apparatus, or the power component or the apparatus includes a processor (e.g., microprocessor(s)) and memory unit coupled to the processor, the memory unit having stored thereon instructions which when executed by the processor, causes the processor to: receive a request create or make the nail polish of a given color and/or to activate the ink deposit component to release the ink to flow to the nail polish holder area. The request can be received over a network including wirelessly over a wireless network. The memory unit can further include instructions which when executed by the processor, further causes the processor to: activate a motor to rotate the nail polish holder area to mix the ink to create the nail polish of the given color.

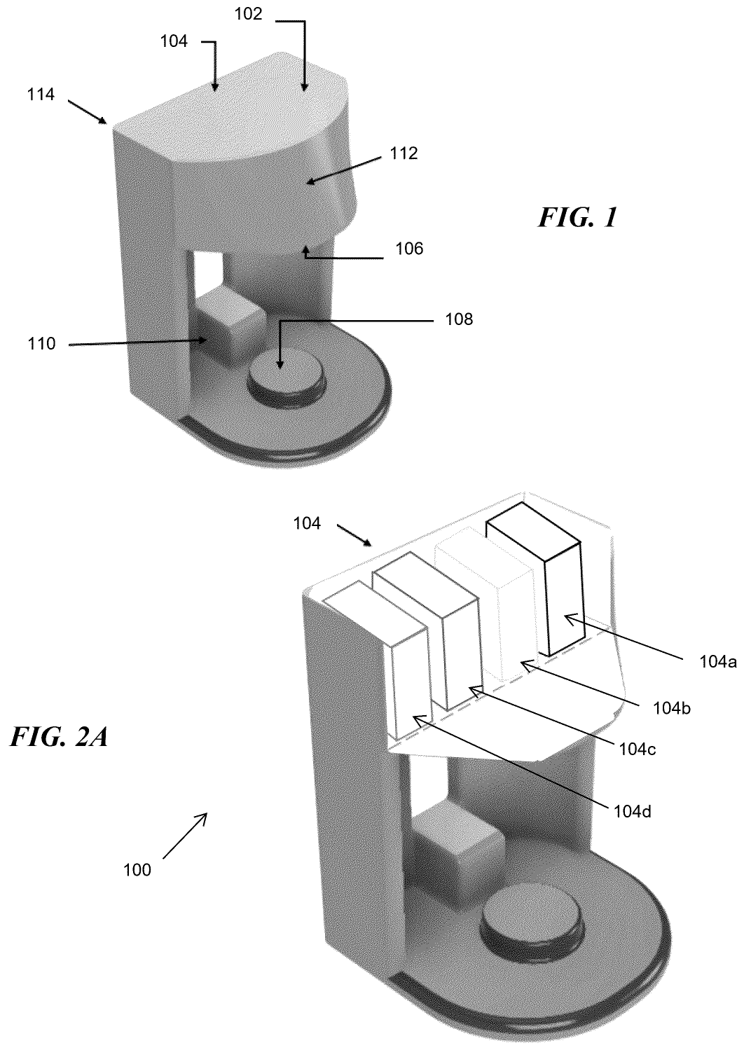

FIG. 1 depicts a view of an example apparatus 100 to make nail polish, in accordance with embodiments of the present disclosure.

The apparatus 100 can generally include, a power and electronics area 102 (e.g., a power component, a power module, a power element, etc.), an ink retention area 104 (e.g., an ink retention unit, an ink retention module, an ink retention compartment, etc.), an ink deposit/deposition area 106 (e.g., an ink deposit/deposition component, an ink deposit module, an ink deposit region, an ink deposition compartment, etc.), a nail polish holder area 108 (e.g., a nail polish holder region, a nail polish holder compartment, a nail polisher holder module, etc.), a nail polish mixing area 110 (e.g., a mixing area, a mixing component, mixer, a mixing module, etc.), a user interface 112 area (e.g., a display component, a display, a touch screen, etc.) and/or a housing area 114 (e.g., housing unit, housing).

The power and electronics area is where the disclosed system and apparatus (e.g., device) can receive the necessary energy to turn on and operate, running that energy through a processor (e.g., microprocessor and/or microcontroller). The microprocessor and/or microcontroller can process and relay the user input commands from the user interface area to the release controls in the ink deposit area.

The ink retention area is where the different colored inks are held separately so that they can be used individually or together depending on need. These inks may be pigment based, water based, or a combination of. This area is connected to the ink deposit area.

The ink deposit area is where release controls are placed to regulate how much of each ink is released from the ink retention area and out of the device. The released ink will then flow/fall into the nail polish holder area where the ink can be placed inside the nail polish bottle. The nail polish mixing area can be the same as the nail polish holder area or it can be located in a different area of the device.

The nail polish mixing area is where the nail polish bottle with the released inks inside of the bottle can be placed to be rotated by a motor, thereby causing the nail polish and the released inks to mix with each other into a homogeneous mixture.

The user interface area is where the user can control the release control mechanisms in the ink deposit area as well as the motor in the nail polish mixing area. This gives the user full control of all functions of the device.

The housing is a structure that holds all the areas together: power and electronics area, ink retention area, ink deposit area, nail polish holder area, nail polish mixing area, and user interface area.

The ink retention system can be where the ink device is stored and released to the ink depositing area. The ink retention system creates an environment where the ink is not able to evaporate, leak, and/or coagulate in the storage container.

The ink storage containers can be referred to and/or thought of as an ampule, tank, cartridge, pod, cup, and/or chamber. To release the ink from the ink retention area to the ink depositing area, and relieve the vacuum generated inside the ink storage container, the ink storage container can for example, utilize a valve to regulate the air pressure within the ink storage container vs outside the ink storage container. There are generally different ink storage containers within the ink retention system; one for each of the ink colors used in the apparatus (e.g., device). This is to ensure that the different inks do not mix with each other while they are stored or released to the ink depositing area. Each of the ink storage containers can hold a minimum of 30 ml of volume of ink. The ink storage containers should be leak proof and made out of material that does not wear down by containing liquids, such as water-based and/or pigment based formulas of inks.

In one embodiment, the ink storage containers include an authentication system that is able to read and/or identify the type of ink and/or ink storage containers in the apparatus. This can include a digitally and/or physically keyed relationship between the apparatus and/or an electronic medium, such as but not limited to a QR code and/or a data storage chip with identification bit memory cells on the ink storage containers. This can be used to assure that the attached ink storage containers are approved for use with the apparatus. In some cases, the ink storage containers can be removable from the device. To remove the ink storage containers from the apparatus, the ink storage containers can slide, unclip and/or rotate out of the apparatus. The housing of the device can integrate hinges, sliding parts, and/or snap parts to open and close the opening where the ink storage containers may be removed from the apparatus. The ink retention system is generally compatible with water-soluble and/or pigment based formulas of ink.

In some embodiments, the apparatus is integrated with a heating and/or cooling system to affect the properties of the water-based and/or pigment based inks to move and/or perform better in the ink retention and/or ink deposit areas.

For a learning educational kit build embodiment of the apparatus, the ink retention system can be represented as one piece that includes all the different ink storage containers for the different colored inks, making sure that the different ink colors do not mix or leak into each other. This one piece ink retention system can be easy to install into the overall housing. The ink retention system can also be created to embody different levels of removability from the housing and ink refill capability.

These changes could create the following examples of housing removability and ink refill capability for the ink retention system.
The ink storage containers in the ink retention area are not removable and do not have an opening for refills.
The ink storage containers in the ink retention area are not removable but have an opening to allow users to refill the storage containers with more ink.
The ink storage containers in the ink retention area are removable and have an opening to allow users to refill the storage containers with more ink.
The ink storage containers in the ink retention area are removable and can be exchanged for new ink storage containers when the user needs to have more ink.

The ink deposit area can be where the ink travels to from the ink retention area and is released out of the device and into a nail polish bottle that is in the nail polish holding area. The ink deposit area can have a release control (e.g., actuator) per the different ink colors. This is to ensure that the inks do not mix with each other while being pushed through the release controls and/or out of the device. For a kit build embodiment of the device, the ink deposit system can be represented as one piece that includes all the different release controls for the different colored inks, making sure that the different ink colors do not mix or leak into each other.

Once the different colored inks are released by their respective release controls, the inks can flow through a funnel that leads the inks into a target area to drop into the nail polish bottle. The funnel can be removable from the housing for cleaning and maintenance purposes. The funnel can be configured keep the different colored inks separate from each other until they are released at the end of the funnel. For the ink deposit area, the release controls (e.g., actuators) can be changed to better regulate the flow of the ink being released to the following:
The release controls can be in the form of solenoid valves.
The release controls can be in the form of peristaltic pump
The release controls can be in the form of motors
The release controls can be in the form of pumps
The release controls can be in the form of a plunger and/or syringe design

The ink deposit area can include or be coupled to have an integrated camera that connects to the power and electronics area of the device as well as the user interface area. The camera could be used to help position the nail polish bottle below the ink deposit area, view and/or record the inks being deposited into the nail polish bottle, view and/or record the deposited inks being mixed with the white polish inside the nail polish bottle. The camera could also be used by the user interface software application to have the user “try on” a nail polish color onto their fingernails using augmented reality prior to the user creating the color of nail polish with the system.

In one embodiment, the nail polish holder area is located below the ink deposit area of the device, This is where the nail polish bottle can catch or receive the deposited inks that flow out of the ink deposit area, through and out of the funnel. The nail polish bottle can be positioned in one of many different orientations. This can be accomplished by having the nail polish bottle sit statically below the ink deposit area or within a nail polish holder that is attached to the housing (e.g., at a base region of the housing). The nail polish holder can be rotated and/or moved to allow the nail polish bottle to sit under the target area created by the funnel from the ink deposit area. The Z-directional centerline (e.g., vertical or plane that is substantially or near vertical to the ground plane) of the funnel where the inks are deposited from and into the nail polish bottle should align with the Z-directional centerline of the nail polish bottle neck. This is to ensure that the deposited inks fall into the nail polish bottle and do not drip over, and/or outside and/or inside the sides of the neck of the nail polish bottle. For a learning educational kit build embodiment of the device, the nail polish holder area can be represented as one piece (e.g., a single unti) that includes the nail polish holder or marker where the nail polish bottle should go under the ink deposit area of the device.

Regarding the nail polish holding area of the device, the space used in the housing for this can also be used for or include components for additional features and functions. For example,
The nail polish holder area can be a standalone area where the nail polish is placed onto a flat surface to receive the released inks.
The nail polish holder area can be a standalone area where the nail polish is placed onto a nail polish holder to receive the released inks.
The nail polish holder area can be shared with (co-located with) the nail polish mixing area. The nail polish is placed into a nail polish holder to receive the released inks. The user can then cause the nail polish holder to rotate and mix the nail polish and the released inks into a homogenous mixture.

The nail polish mixing area is where the nail polish bottle that includes both the white polish and the deposited inks released from the ink deposit area can be mixed together into a homogenous mixture. The nail polish mixing area can include a motor and/or an electromagnetic system to cause the white polish and the deposited inks to mix together.

The nail polish bottle can be locked into place for the duration of the mixing process by utilizing the previously mentioned nail polish holder and/or another holder device. The nail polish bottle with the white polish and deposited inks can be locked into place so that the bottle and the contents do not spill or fall out of the nail polish mixing area by having the nail polish bottle be strapped into a nail polish holder device, press-fit into a holder device, and/or utilize a spring clamp to keep the nail polish bottle retained in the nail polish mixing area.

Strapping the nail polish bottle can be implemented by the nail polish bottle being placed onto a holder base with a strap of velcro, string, or other material that can either be tied to itself or latched onto a pin to keep the nail polish bottle within the strap and the holder base. The press-fit holder can enable the nail polish bottle with the white polish and deposited inks to be pushed into the holder by hand pressure and the pressure between the holder and the nail polish bottle would be sufficient to keep the nail polish bottle within the holder during the mixing process. Utilizing a spring clamp to keep the nail polish bottle within the holder can be implemented similar to the press-fit, but the nail polish bottle wouldn't need to be pushed into place by pressure. Instead the nail polish bottle can be placed into the holder without any pressure and the spring clamp can be adjusted to tighten around the nail polish bottle and keep it within the holder during the mixing process.

In another example, the nail polish mixing area can be in the same area as the nail polish holder area, where the nail polish holder and/or holder devices can be the same for both the nail polish holder area and the nail polish mixing area. The nail polish mixing area can also be placed to the side of the housing base of the device so that the nail polish bottle with the white nail polish and deposited inks are not under the ink deposit area. For example, the nail polish mixing area can be shared with the nail polish holding area or be separate.
The nail polish mixing area is within the same area as the nail polish holding area. The nail polish is mixed in the same place as where it receives the released inks.
The nail polish mixing area is in a different area from the nail polish holding area but is still part of the housing.
The nail polish mixing area is a separate area from the housing.

For a learning educational kit embodiment of the system, the nail polish mixing area can be represented as one or more pieces that include the motor and/or nail polish holding device, so that the nail polish mixing area can be attached under the ink deposit area or to the side of the housing.

The device can also include a user interface area (e.g., display). The user interface area can be where the disclosed system/apparatus receives the input and commands from the user. This can be separate and/or integrated with the microprocessors and/or microcontrollers from the power and electronics section that are necessary to control the system. The user interface area can be in the same area as the power and electronics area or can be placed in a different area inside or outside of the device.

For the user interface area, the way the user interacts with the system can include any one of or a combination of:
The user interface area can be an integrated touchscreen that is in the housing of the device.
The user interface area can be a smartphone, tablet or any other portable electronic device with a software application.
The user interface area can be a smartphone, tablet or any other portable electronic device with a software application that has voice command.
The user interface area can be a computer with a software application.
The user interface area can be a smart wearable with a software application.
The user interface area can be a smart wearable with a software application that has voice command.

In some embodiments, the user interface area depicts or renders interactive content during the nail polish making and mixing process that can include for example, games, chat, rewards, video, audio, interactive polls. For a learning educational kit build embodiment of the device, the user interface area can be represented as one piece that allows the user to input a command for the system that can assembled into the kit, such as an integrated touchscreen, and/or utilize an external device with a software application to relay the user input command to the system.

If the user interface used to communicate with the device/system is provided by an external device such as a smartphone, tablet or portable electronic device, there can be a cradle and/or attachment to hold the user interface to the system. Alternatively there can be a cut out within the housing to allow for the smartphone, tablet or portable electronic device to rest. This can enable the user interface to be placed and held in either a vertical or horizontal position. This would allow for a more comfortable user interaction with the system and potential viewing/recording of the nail polish mixing and making process, and also enabling and facilitating a hands free experience.

The device includes a housing unit (e.g., housing, housing base) within which some or all of components listed above are housed and integrated. The housing can be made from or include material that is lightweight such as plastic, materials reinforced with Nylon, and/or a variation of aluminum and/or steel to make it easier for the device to be moved. The size of the housing base can be as small as the other sections will allow so that the device can comfortably sit on tabletops and small furniture. The housing can also have an attachable, removable or integrated handle that makes it easy for the user to transport the device. The housing can also be collapsible to allow for easy mobility and transport.

In one embodiment, the housing includes parts that are easily assembled. The assembly of the housing can utilize interlocking part designs, snap fit designs, and/or press-fit designs. With an interlocking part design for the housing, the housing can come in parts and can be assembled together using glue and/or connectors such as screws, pins, and/or latches. A snap fit design can include two parts interlocking and staying assembled without the use of glue or connectors, through systems like a cantilever and/or annular snap fit designs. A press-fit implementation would also allow for assembly without glue or connectors, and instead utilize pressure to push one part into the other and keep the parts retained with each other.

Examples of the a press-fit implementation can include a ball joint and/or quick fit couplings. By utilizing one or more of these assembly techniques, the system can be made into a learning educational kit. The kit can have various features that can include a modular version that allows the device to attach to or become attached to other potential accessories such as a nail dryer and other nail printer. The system could also come with Computer Aided Design (CAD) files that utilize some or all of the assembly techniques to provide a 3 dimensional (3D) printable embodiment of the device's housing.

The power and electronics area of the device is where the device receives the energy necessary to turn on and power all the electronic components used. The device can be powered through the use of a battery, a USB connection to a secondary device, and/or through a wall outlet using a power supply. The power and electronics area can also include or be electronically coupled to the microprocessor and/or microcontrollers (e.g., the processor(s) and memory unit) used to operate the device. The microprocessor and/or microprocessors take the command input from the user interface area to relay them to the ink deposit area and the nail polish mixing area that include control systems that need commands from the user.

Additionally, the power and electronics area controls when and how the device is turned on/off. The device can be turned on/off by utilizing a push button control, voice control, and/or an external application. The microprocessor and/or microcontroller can be updated through the network interface of the device. For example, updates can occur over a wired connection such as USB and/or with Over-the-Air Updates (OTA) through Wi-Fi and/or Bluetooth and/or an internet connection. This enables the system hardware and electronics to be updatable even after the device has been purchased. This allows for in the field maintenance and premium futures to be introduced.

In one embodiment, the device includes have electronic components that provide a feedback loop of data from the release controls back to the microprocessor/microcontroller. These components that provide feedback data can include components that can measure the amount of volume being released from the ink deposit area and the color being created in the nail polish mixing area, such as but not limited to a water meter and/or a color reader. The information gathered from the components, microprocessor and/or microcontroller may be error codes and/or hooks associated with the hardware and/or firmware of the system. This enables the manufacturer of the device to troubleshoot and improve the user experience.

The error codes and/or hooks generated and/or gathered can include for example, authorization of the ink storage containers and/or inks, information on ink levels, status of motors, valves, and/or pumps, and/or connection status between the device and an external component such as a smartphone, table, or portable electronic device. The information generated from the feedback components can be stored on the local or cloud based servers. For a learning educational kit build embodiment of the device, the power and electronics area may be represented as one or more pieces that include the power device for the device, the microprocessor and/or microcontroller, and wiring/electronic connections. The microprocessor and/or microprocessor can also be coded by the user as instructions and/or code files can be shared as part of the STEM (Science, technology, engineering and mathematics) kit.

The power and electronics area of the device can be located in various areas of the device. In some embodiments of the device it is housed closer to the top of the device. In alternative embodiments of the device, the power and electronics may be situated in other parts of the device that have enough space and/or access for the electronic components to fit and operate safely.

The nail polish bottle used in the nail polish holder area and nail polish mixing area can be made out of plastic, glass, or other leak proof material that can keep the white polish and deposited inks from spilling out of the nail polish bottle. The nail polish bottle neck is generally large enough to allow the deposited inks to fit through the neck of the nail polish bottle without dripping over and/or inside and/or outside the neck of the nail polish bottle. The height of the nail polish bottle without the cap is generally small enough to fit between the base of the nail polish holder device from the nail polish holder area and the bottom of the funnel in the ink deposit area. The height of the nail polish bottle with the cap is generally small enough to fit between the base of the nail polish holder device from the nail polish mixing area and the bottom of the funnel in the ink deposit area if the nail polish mixing area is placed in the same location as the nail polish holder area.

Additionally, the nail polish bottle cap should create an airtight seal so that the white polish and/or the deposited inks do not leak, evaporate, or coagulate. The nail polish bottle cap can include a nail polish brush that can be used to apply the created polish onto fingernails. In one example, the nail polish bottle stores a minimum of 4 ml of white polish. The nail polish bottle holds white nail polish, called white polish, as it is a practical and popular starting point to create different colors in painting applications. White polish is generally widely available and provides the deposited inks a base material to mix with to create the different colored polishes. The white polish provides the material and chemical makeup that gives the created colors from the deposited inks the ability to be painted onto fingernails as nail polish. The white polish can be gel, water and/or lacquer based. The white polish or other base polish utilized is selected to be compatible with and mix homogeneously with the water-based and/or pigment based inks.

The user interface can include a software application to relay user inputs to the system. The application can have different forms to match and integrate into the different possible user interface options. The application enables the user to create different colored polishes by depositing ink from the ink deposit area into the nail polish holder area and/or to mix the deposited inks into the white polish through the nail polish mixing area of the device. The user will be able to choose the desired color to be created by using a color picker, and/or inputting RGB (red, blue, green), CMYK (cyan, magenta, yellow, black), and/or Hex (hexadecimal) codes for a particular color.

The user can then be able to select how and when to have the nail polish mixing area mix the deposited inks into the white polish in the nail polish bottle. The application can store the user's selections, created colors, and overall history using the application on a local server that would reside inside the device and/or on the user interface and/or on a cloud server. The servers would collect and store user profile information and user habits to be used to better the application and system. The application can allow the user to share, download and/or recommend colors to be created and mixed.

In a further example, the application can control one or more cameras that are located within the device and/or are part of the external user interface area (i.e. the cameras of the smartphone, tablet, portable electronic device). The optional internal camera of the device or the external user interface area camera(s) serve multiple purposes.

For example, it calibrates and provides diagnostic information on the speed, distance, positioning of the nail polish bottle and components relative to the ink dispensing. It can also aid the user to position the nail polish bottle below the ink deposit area, view and/or record the inks being deposited into the nail polish bottle, display and/or record the deposited inks being mixed with the white polish inside the nail polish bottle via the user interface. The recording and photography of the nail polish making and mixing enables the user to share that all or part of the making experience on her digital social networks or to her user profile or on the system's local device or server.

In a further embodiment, the camera(s) also enable the integration of a virtual manicure via the software running on the user interface—it lets a user try a certain polish color on before printing or making it. Specifically, a user places their fingernail/fingernails on the nail polish base staging area before the bottle is placed there, and the internal camera or portable electronic device camera(s) detects their fingernail in 2d and/or 3d and performs image processing and computer vision techniques to map their fingernail and real time allow virtual placement of the color of nail with the selection the user chooses.

The application can save the user's virtual manicure images, video and color selection saved in the software or the user profile. The software application that can run on the user interface of the system. The software application performing virtual manicures could also run separately on an external device like a portable electronic device (i.e. smartphone, tablet) whereby the user can try on different colors via a color wheel or color picker or any of the system's options. The user can for example, use the front and/or back facing camera(s) of the portable electronic device and can hold her hand or finger(s) against any background for the polish and/or art to be displayed on her nail. (This is instead of using the nail polish base staging area as a staging area for the fingernail). The user can then save the virtual manicure or her color selections so that they could later make and mix that color with the device.

The application can be updated through a wired connection such as USB and/or with Over-the-Air Updates through Wi-Fi and/or Bluetooth and/or an internet connection. The application can trigger an update to both the software and hardware components of the system. For a learning educational kit build embodiment, the user interface application can be represented as one piece of software that allows the user to input a command for the system that can be used in conjunction with the assembled kit. The kit application can have an open source feature that enables user customization where the user can modify and alter the User Interface/User Experience (UI/UX) to better fit how they would like to interact with the system.

Additional or less components/modules can be included without deviating from the techniques discussed in this disclosure. In addition, each module/component can include any number and combination of sub-modules, and systems, implemented with any combination of hardware and/or software modules.

The apparatus 100, although illustrated as comprised of distributed components (physically distributed and/or functionally distributed), could be implemented as a collective element. In some embodiments, some or all of the elements, and/or the functions represented by each of the modules can be combined in any convenient or known manner. Furthermore, the functions represented by the modules can be implemented individually or in any combination thereof, partially or wholly, in hardware, software, or a combination of hardware and software.

The apparatus 100 can include a network interface (not shown)which can be a networking module that enables the apparatus 100 to mediate data in a network with an entity that is external to the apparatus 100, through any known and/or convenient communications protocol supported by the host and the external entity. The network interface can include one or more of a network adaptor card, a wireless network interface card (e.g., SMS interface, WiFi interface, interfaces for various generations of mobile communication standards including but not limited to 1G, 2G, 3G, 3.5G, 4G, LTE, 5G, etc.,), Bluetooth, a router, an access point, a wireless router, a switch, a multilayer switch, a protocol converter, a gateway, a bridge, bridge router, a hub, a digital media receiver, and/or a repeater.

As used herein, a “unit,” a “component,” and “element,” an “area,” a “region,” a “compartment,” a “module,” a “manager,” an “agent,” a “tracker,” a “handler,” a “detector,” an “interface,” or an “engine” can include a general purpose, dedicated or shared processor and, typically, firmware or software modules that are executed by a processor. Depending upon implementation-specific or other considerations, the unit, the module, detector interface, component, element, region, area, manager, compartment, tracker, agent, handler, or engine can be centralized or have its functionality distributed in part or in full. The unit, the module, detector interface, component, element, region, area, manager, compartment, tracker, agent, handler, or engine can include general or special purpose hardware, firmware, or software embodied in a computer-readable (storage) medium for execution by the processor.

As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, flash, optical storage, to name a few), but may or may not be limited to hardware.

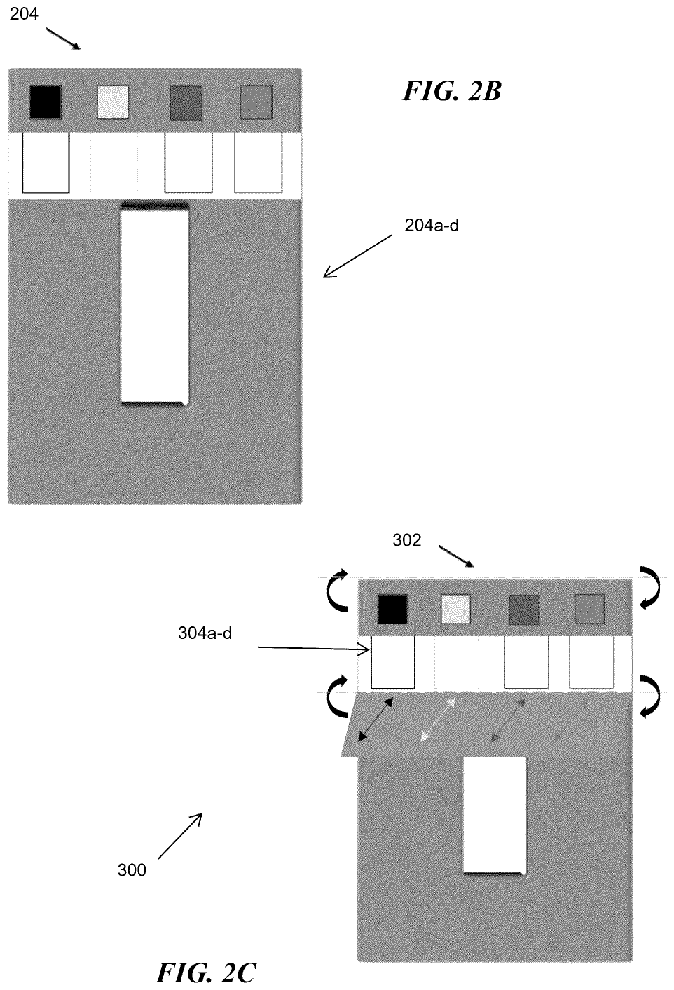

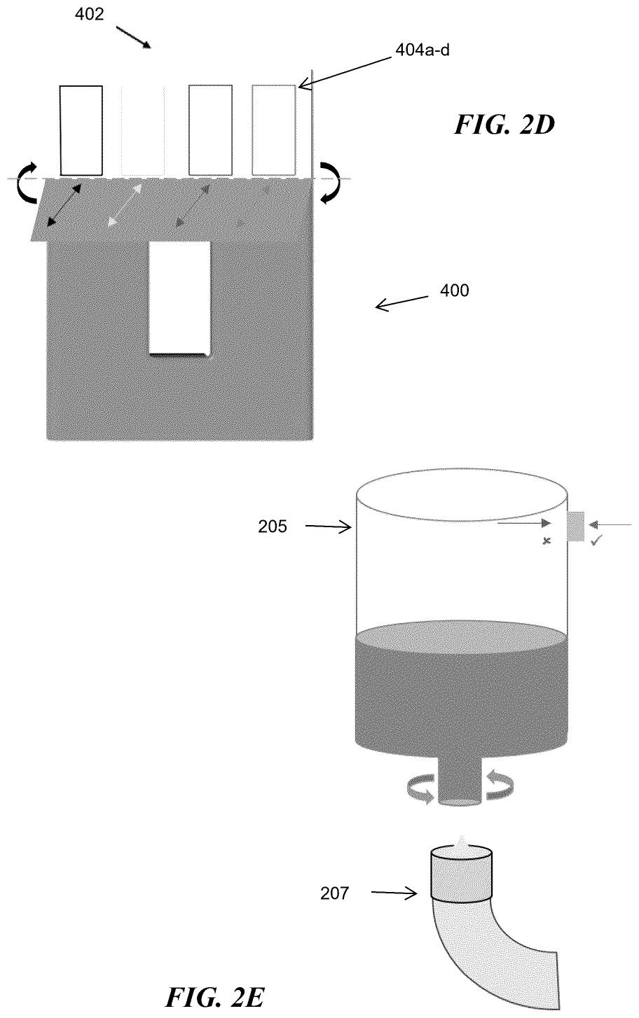

FIG. 2A-2E depict multiple views of an example ink retention area 104 of the apparatus 100 to make nail polish, in accordance with embodiments of the present disclosure.

In the example of FIG. 2A, the ink retention area 104 is located towards the back of the apparatus 100 and includes one or more ink storage containers 104a-d having ink of different colors. The configuration shown in the example of FIG. 2A does not allow one or more ink storage containers 104a-d to be removed from the apparatus 100 and does not have a refill ability.

FIG. 2B depicts a further embodiment of an apparatus 200 where an ink retention area 204 comprises one or more ink storage containers 204a-d that are refillable with ink. In one embodiment, the ink storage containers 204a-d are not removable from the device (apparatus 200) and an opening can be formed or created for each of the ink storage containers 204a-d so that the user can open the perspective opening and refill or replenish any given ink storage container with the necessary ink color.

FIG. 2C depicts a further embodiment of an apparatus 300 where an ink retention area 302 comprises one or more ink storage containers 304a-d that are refillable with ink. In one embodiment, the ink storage containers 304a-d are also removable from the device (apparatus 300). Note that the ink storage containers 304a-d can be configured to be disposed inside the device or outside the device.

For example, the back top part of the device can include panels that rotate up and down using a hinge system to allow access to the ink storage containers 304a-d that can be removed and also have the refill access areas. It is contemplated that other mechanical configurations and/or design approaches can be implemented to facilitate removal of the ink storage containers 304a-d from the housing, in accordance with embodiments of the present disclosure.

FIG. 2D depicts a further embodiment of an apparatus 400 where an ink retention area 402 comprises one or more ink storage containers 404a-d that are removable from the back of the device (apparatus 400). In this example, the ink storage container 404a-d are not refillable and the user can replace the ink storage containers 404a-d with new ones as.

FIG. 2E depicts an example of a configuration of an ink storage container. The ink storage container in the ink retention area can include a tank 205 (e.g., a cylindrical tank) that can store a single ink color. The ink storage container can be rotated or screwed into place in the ink retention area to move the ink from the ink retention area to the ink deposit area. The ink storage container can include or be coupled to a valve 207 which can regulate pressure inside and/or outside the ink storage container to facilitate the ink flow from the ink retention area to the ink deposit area. The ink storage container can be sealed prior to installation into the device (apparatus 100), for example, via a small film to seal the ink storage container. When the ink storage container is screwed into place within the device, the film seal is punctured by the ink retention area and allows the ink within the ink storage container to flow out of the storage container and into the ink deposit area.

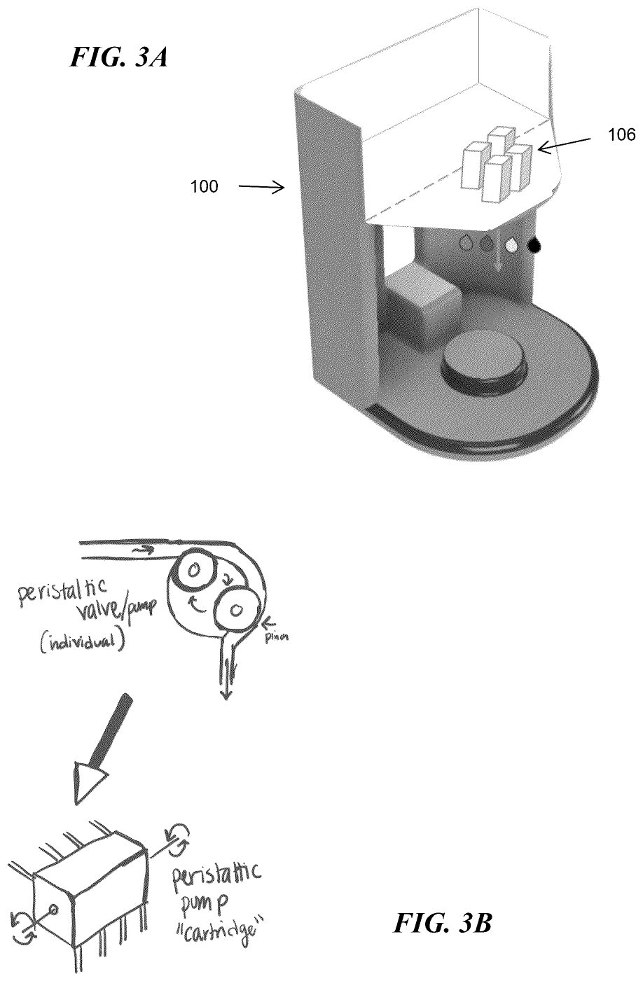

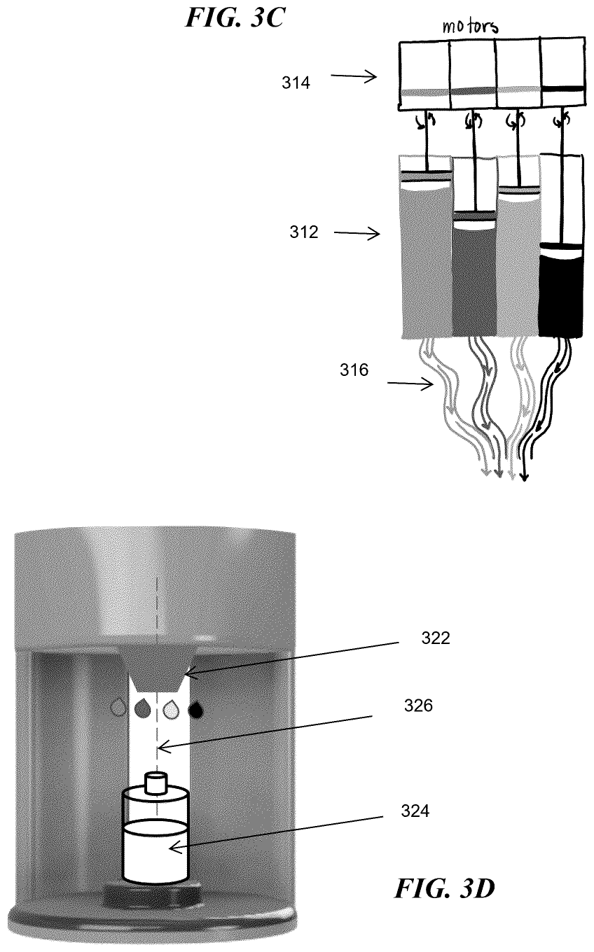

FIG. 3A-3D depict multiple views of an ink deposition area 106 of the apparatus 100 to make nail polish, in accordance with embodiments of the present disclosure.

In FIG. 3A, the ink deposition area 106 is configured or disposed to be towards the front of the device 100. In one embodiment, solenoid valves are used to deposit the inks over the nail polish holder area 108. There can be a solenoid valve per color of ink.

The device (e.g., apparatus 100) can include peristaltic pump system (as shown in the example of FIG. 3B) that squeezes the inks from the ink retention area 104 of the device to the ink deposit area 106. To consolidate on space and rotating motors, the peristaltic pump can utilize one singular motor that rotates that different peristaltic pumps for a different colored ink. To individually control the individual peristaltic pumps using one rotating motor pin, an engage and disengage system for each of the peristaltic pumps would be created. Through a mechanical or electrical trigger a gear tooth could be engaged and latch onto the rotating motor pin so that the individual peristaltic pump will being to move and pump the inks through the different areas.

As illustrated in the example of FIG. 3C, the ink deposit area can have a syringe system and/or plunger system 312 to dispense the inks 316 into a nail polish bottle. Additionally, the ink deposit area can further include one or more motors 314 integrated with the system of syringes and/or plungers 312 to cause the individual plungers to push down and deposit ink 316 into the nail polish bottle.

As shown in the example of FIG. 3D, a funnel 322 from the ink deposit area (e.g., the ink deposit are 106) needs to align with the neck of the nail polish bottle 324. The centerline 326 of the funnel 322 and the nail polish bottle 324 therefore should be aligned so that the deposited inks do not spill over and/or outside and/or inside the neck of the nail polish bottle.

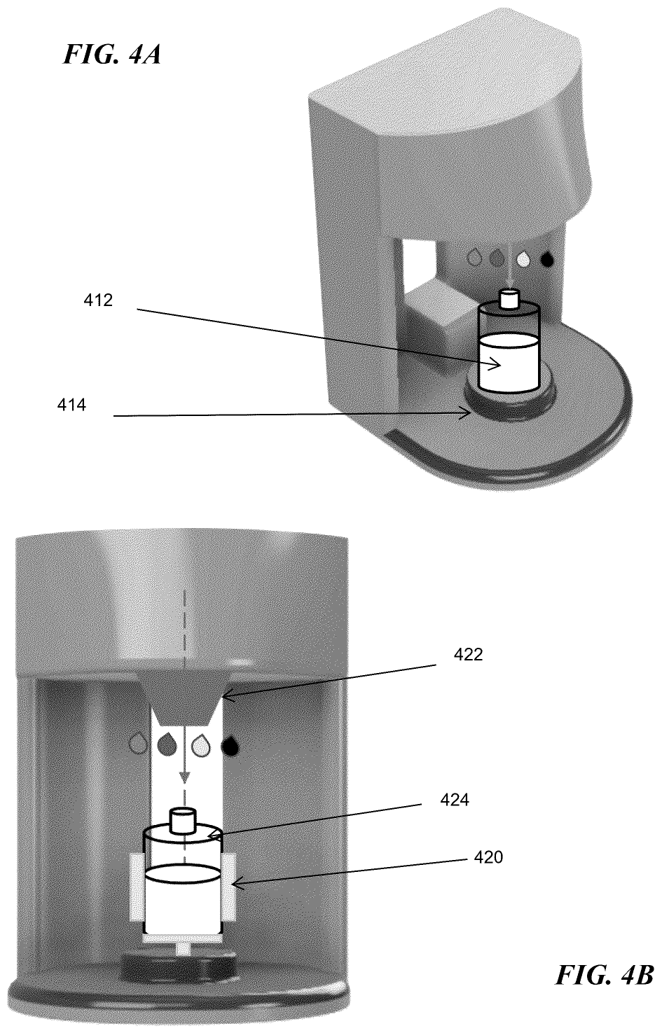

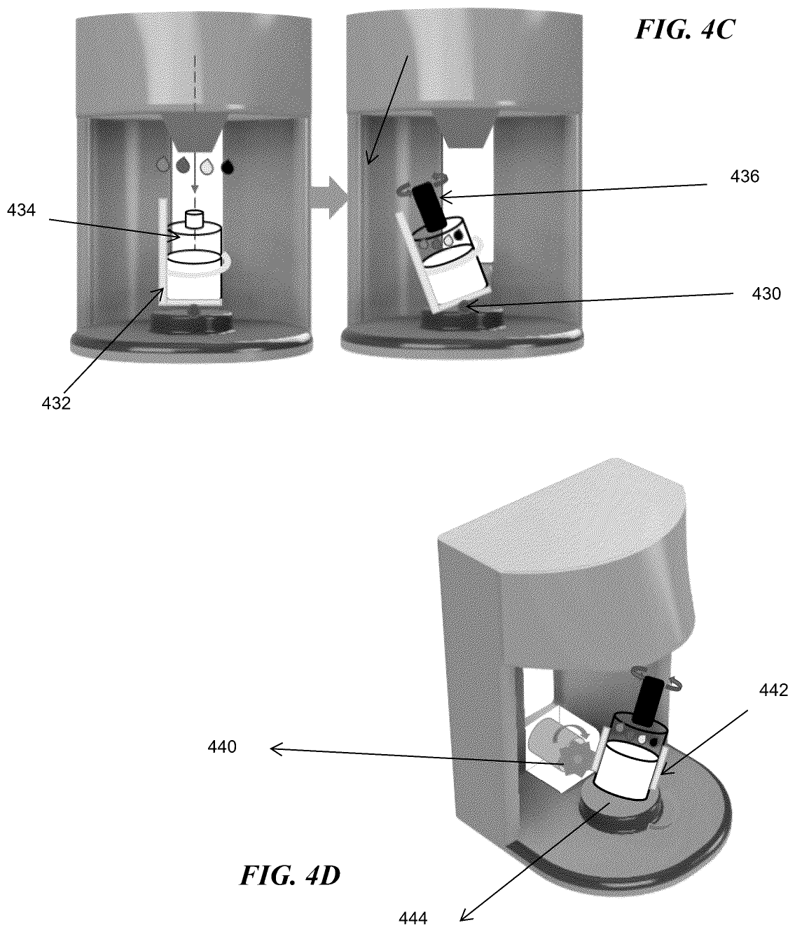

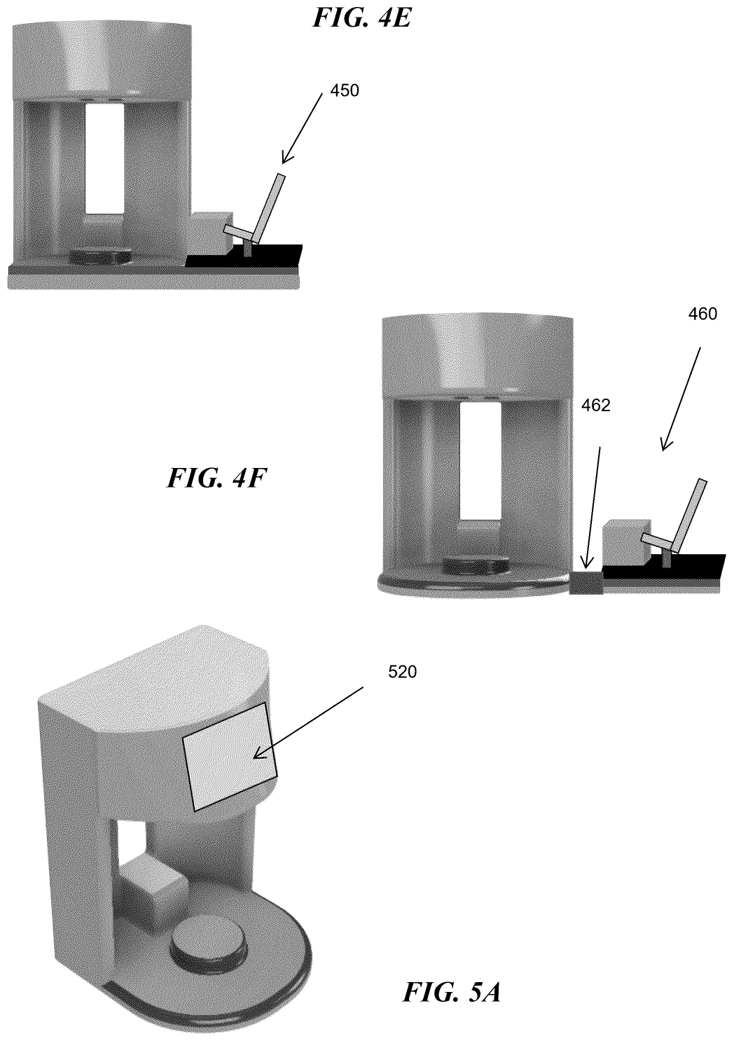

FIG. 4A-4F depict multiple views of a nail polish mixing area of the apparatus to make nail polish, in accordance with embodiments of the present disclosure.

FIG. 4A depicts an example of a nail polish holder area (e.g., the nail polish holder area 108) that is located toward the front bottom of the device (e.g., apparatus 100). The nail polish holder area can be below the ink deposit area (e.g., the ink deposit/deposition area 106). In this example, the nail polish bottle 412 that holds the white polish is sitting on the flat static base 414 of the nail polish holder area.

In one embodiment, the nail polish holder area (e.g., the nail polish holder area 108) can include a nail polish holder device 420 below the ink deposit area (e.g., the ink deposit/deposition area 106), as shown in the example of FIG. 4B. The nail polish holder device 420 can help orient/direct the nail polish into the target area where the centerline of the funnel 422 and the centerline of the neck of the nail polish bottle 424 will be aligned. This can prevent the inks from depositing over and/or outside and/or inside the neck of the nail polish bottle 424.

In a further embodiment, the nail polish holder area (e.g., the nail polish holder area 108) and the nail polish mixing area (e.g., the nail polish mixing area 110) partially or fully share a space in the device (e.g., apparatus 100). As shown in the example of FIG. 4C, the nail polish bottle is strapped into a nail polish holder device 432 and sits open below the ink deposit area (e.g., the ink deposit/deposition area 106). Once the ink is deposited through the neck and into the nail polish bottle 434, a user interface can prompt the user to cap the nail polish bottle prior to mixing. The nail polish holder device 432 can be tilted by the use of a ball joint 430 (e.g., through mechanical coupling) so that the nail polish bottle 434 and its contents sit at an outward angle. Then the nail polish mixing components 436 can spin the nail polish holder 432 sitting at this angle and mix the white polish and the deposited inks inside the nail polish bottle into a homogeneous mixture.

In the example of FIG. 4D, the nail polish mixing area (e.g., the nail polish mixing area 110) is generally situated, disposed or formed in the same area as the nail polish holder area (e.g., the nail polish holder area 108). In one embodiment, a motor 440 integrated with the device (e.g., the apparatus 100) is operable to rotate a nail polish holder device 442. In addition, the nail polish holder device 442 can include a spring clamp 444 to hold the nail polish in place and at an angle. The rotation motion mixes the white polish with the deposited inks.

In one embodiment, a nail polish mixing area (e.g., the nail polish mixing area 450) is a separate area from the nail polish holder area (e.g., the nail polish holder area 108) but is still integrated with and/or forms a portion the device (e.g., apparatus 100) as a single device unit, as illustrated to the example of FIG. 4E. In addition, the nail polish mixing area is integrated with (e.g., physically integrated with) a housing of the device. For example, the nail polish mixing area can be integrated into or coupled to a base of the device. In this example, the nail polish mixing area is not connected to the device via a connection point.

In one embodiment, the nail polish mixing area 460 is external to the device (e.g., the apparatus 100) and the housing of the device, as shown in the example of FIG. 4F. In one embodiment, the nail polish mixing area 460 can be coupled to or connected to the device (e.g., the apparatus 100) via a connection point 462 (e.g., connection device or connection unit), for example, when in operation or all the time In some instances, the nail polish mixing area 460 can be removable or detachable from the device via the connection point 462, for example, for storage while not in operation. Alternatively, the nail polish mixing area 460 can be a completely separate unit or component from the apparatus (e.g., the apparatus 100).

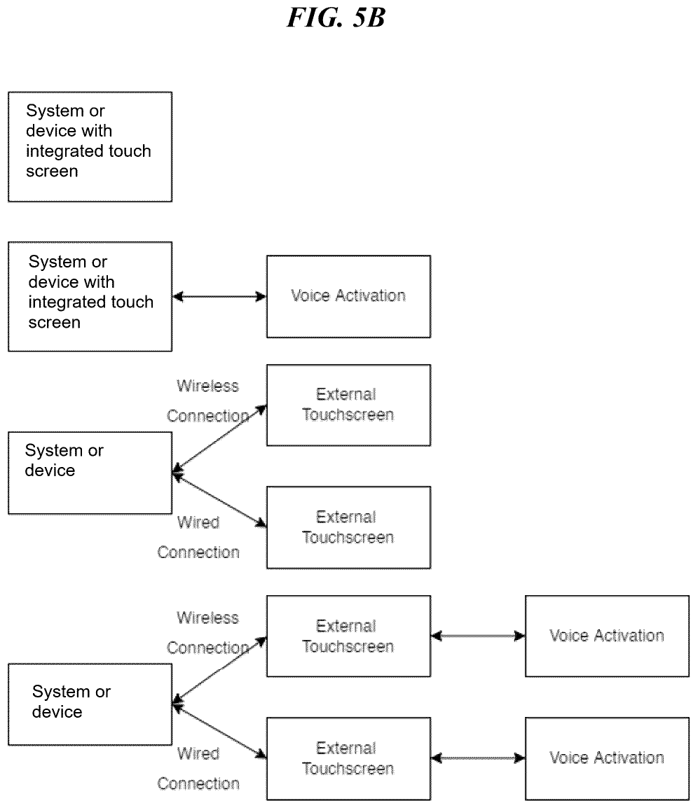

FIG. 5A depicts a view of a user interface area 520 of the apparatus to make nail polish, in accordance with embodiments of the present disclosure.

In one embodiment, the user interface area 520 can be located on the front face of the device (e.g., apparatus 100). For example, the user interface area 520 can include a touch screen integrated with the device. In one embodiment, the system or device (apparatus 100) is embedded with an application enabling a user to input commands via the user interface area 520.

Various different types of user interfaces used to control the system or device (apparatus 100) are contemplated in accordance with embodiments of the present disclosure. FIG. 5B depict s a diagram illustrating examples of various interactions accessible from the user interface area, in accordance with embodiments of the present disclosure. For example, the user interface can be attached to the system or device (apparatus 100), integrated with the system or device (apparatus 100) or be separate from the system or device (apparatus 100). The system or device (apparatus 100) can have voice activation capabilities within the system itself or use an external component to receive the voice activated commands. The system or device (apparatus 100) can be connected to external components via a wireless or wired connection.

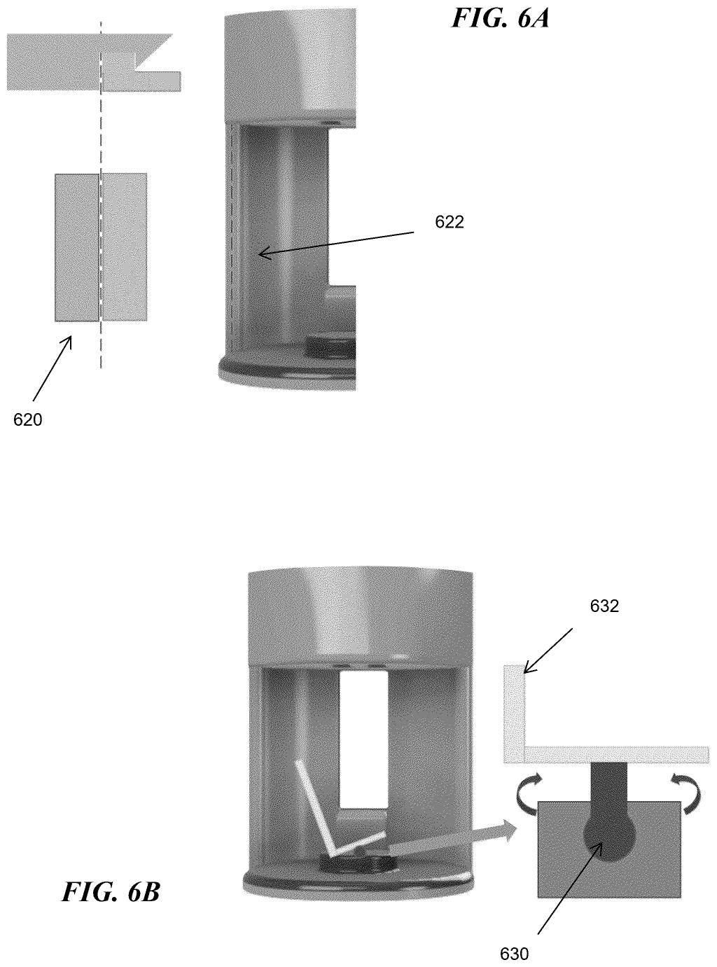

FIG. 6A-6B depict multiple views of a housing of the apparatus to make nail polish, in accordance with embodiments of the present disclosure.

In on embodiment, the housing utilizes use snap fits to assemble parts together without the use of glue or connectors. An example of a snap fit 620 that can be used for the pillar section 622 of the device between two parts is illustrated in the example of FIG. 6A.

For the nail polish holder area and/or the nail polish mixing area, the nail polish holder device 632 can utilize a press fit ball joint 630 to allow the nail polish holder to rotate the nail polish bottle into a suitable or an optimal position to either receive the deposited inks or to mix the white polish and deposited inks within the nail polish bottle during the mixing process, as shown in the example of FIG. 6B.

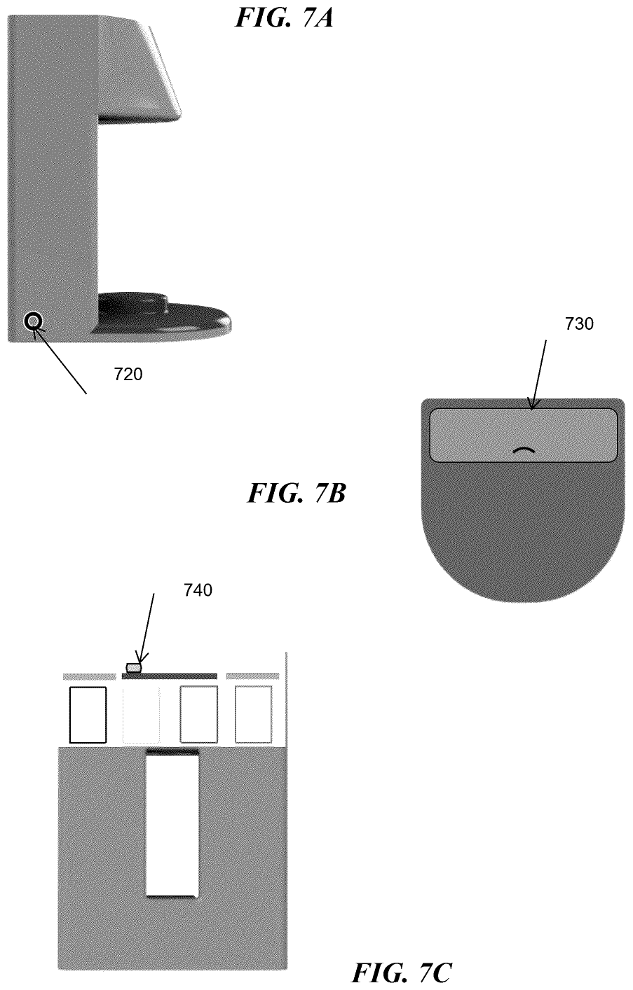

FIG. 7A-7C depict multiple views of a power and electronics area of the apparatus to make nail polish, in accordance with embodiments of the present disclosure.

A power source 720 for the device (e.g., the apparatus 100), if using a power supply that connects to a wall outlet, can be formed on one of the sides of the device towards the bottom as shown in the example of FIG. 7A. A view of the bottom of the device is depicted in the example of FIG. 7B. In one embodiment, the device can be battery operated and the batteries can be inserted from on the bottom of the device. The device can include a battery compartment having a cover that the user can lift and/or remove to exchange or replace the batteries should they run out of energy. In one embodiment, the device includes a USB component which can be utilized to power the device. The USB component may be part of the microprocessor and/or microcontroller, though it does not need to be. As shown in the example FIG. 7C, a USB port 740 or the USB component is formed above the ink storage containers. This configuration is one example of where the electronics may be placed within the device.

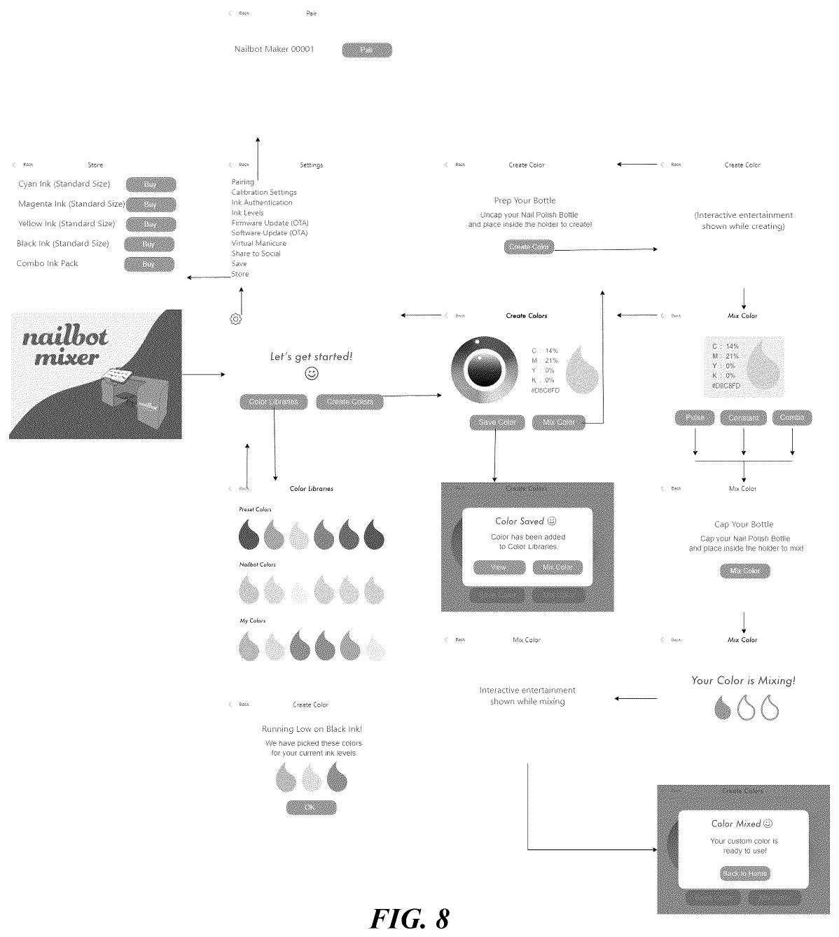

FIG. 8 graphically depict example user interfaces for making nail polish, in accordance with embodiments of the present disclosure. The user flow depicted on the example user interfaces depict example processes for the user to create or customize a color. The system/apparatus can also facilitate a process to trigger the inks to be deposited and then mixed with the white polish in the nail polish bottle.

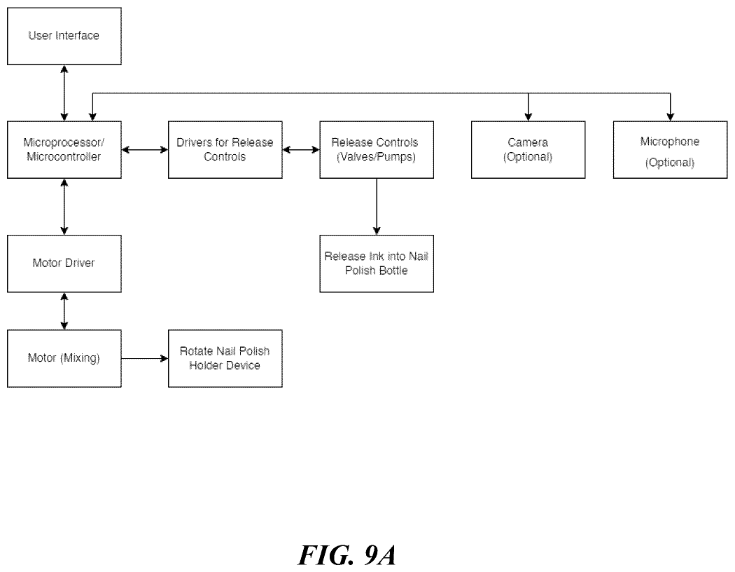

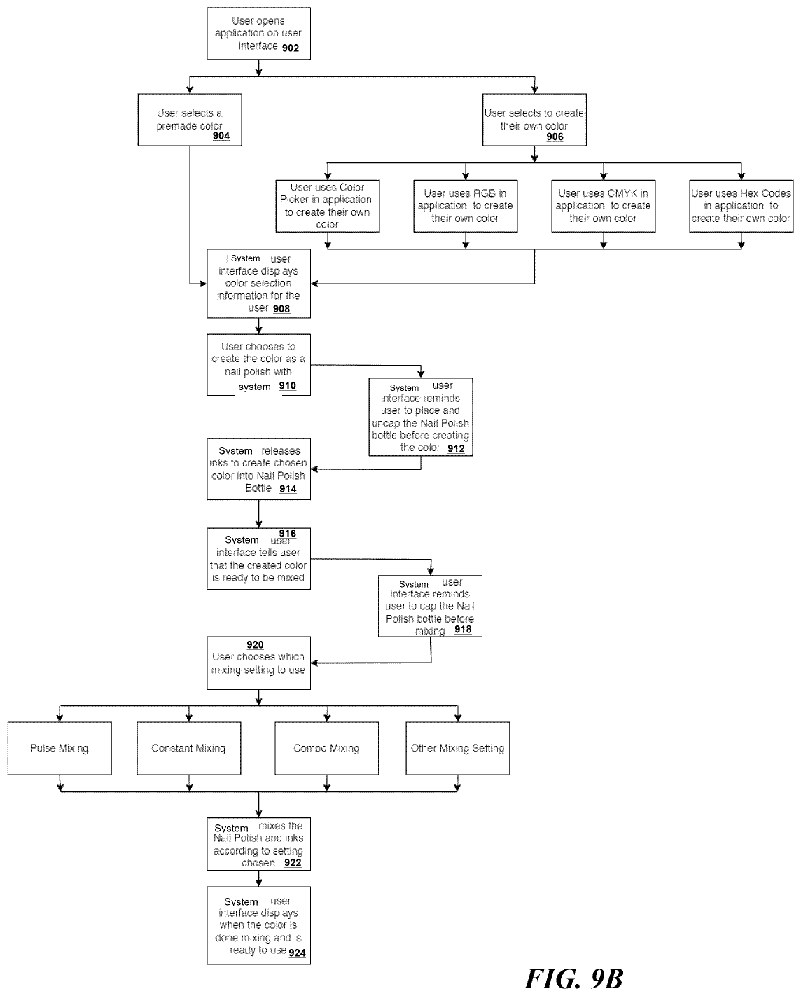

FIG. 9A depicts an example functional block diagram of a system or apparatus that can make or mix nail polish, in accordance with embodiments of the present disclosure.

The system/apparatus includes a microprocessor/microcontroller to help drive and/or the other components in the system. The flow of commands and data can flow from and back into the microprocessor/microcontroller depending on the system embodiments and components as illustrated in the example of FIG. 9A.

FIG. 9B depicts a flow chart illustrating example processes of a system or apparatus to make or mix nail polish, in accordance with embodiments of the present disclosure.

The process flow depicted on the user interface guides the user through functions performed by the system or apparatus. The flow chart of FIG. 9B, illustrates an example of a process flow of a user experience to create and/or select a color, to activate the device to dispense the ink necessary for the selected color, to prepare the nail polish bottle for the mixing process, and/or to mix the polish and released inks inside the nail polish bottle into a homogeneous mixture.

For example, in process 902, a user pens an application on a user interface. The user can select a premade color (e.g., predetermined or preconfigured color), as in process 904. The user can also select to create their own color, as in process 906. To create their own color, the user can for example, use a color picker in the application, or use RGB configuration, use CMYK in the application and/or use HEX codes.

In process 908, the user interface can depict or display the color selection information for the user. In process 910, the user can choose to create the color as a nail polish with the system. In process 912, the system can remind or prompt the user to place and uncap a nail polish bottle before creating the color.

In process 914, the system releases inks to create the chosen color into the nail polish bottle. In process 916, the system notifies the user that the create color is ready to be created or mixed. In process 918, the system reminds or prompts the user to cap the nail polish bottle before the mixing process. In process 920, the user can select or configure the mixing setting to be applied, for example, by pulse mixing, constant mixing, combo mixing, and/or any other mixing settings. In process 922, the system mixes the nail polish and inks according to the setting chosen. In process 924, the user interface depicts a notification when the color is done mixing and/or is otherwise ready to be used.

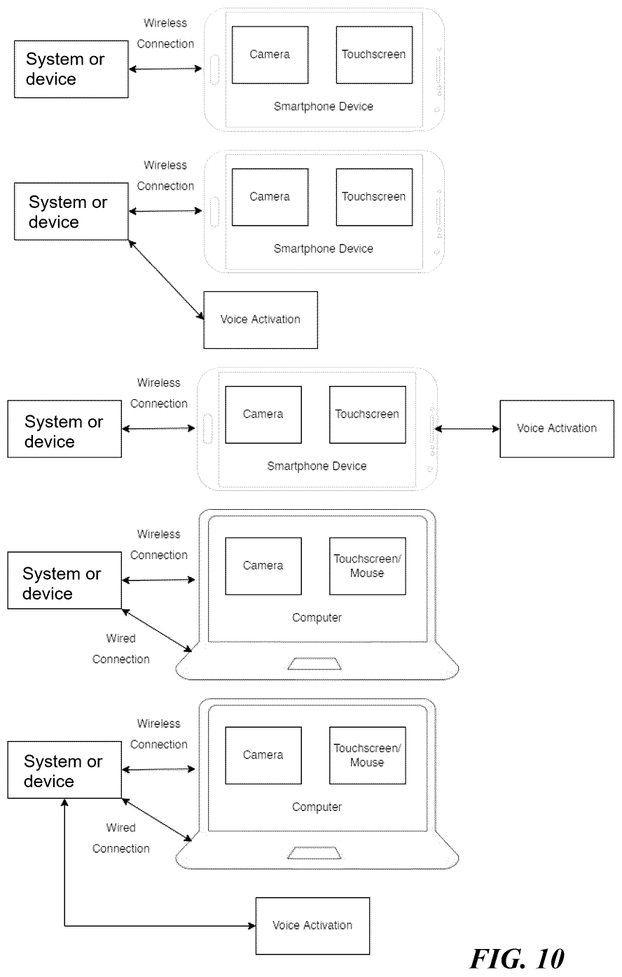

FIG. 10 depicts an example functional block diagrams of a system or apparatus that facilitates nail polish making or mixing, in accordance with embodiments of the present disclosure.

For example, the system can be coupled to a smartphone, tablet or portable electronic device via wired or wireless connections. The smartphone, tablet or portable electronic device can be enabled to be operable to control the system through voice command as well. In one embodiment the system can work with the smartphone, tablet, or portable electronic device while the system is capable of carrying out voice activated commands from the system itself.

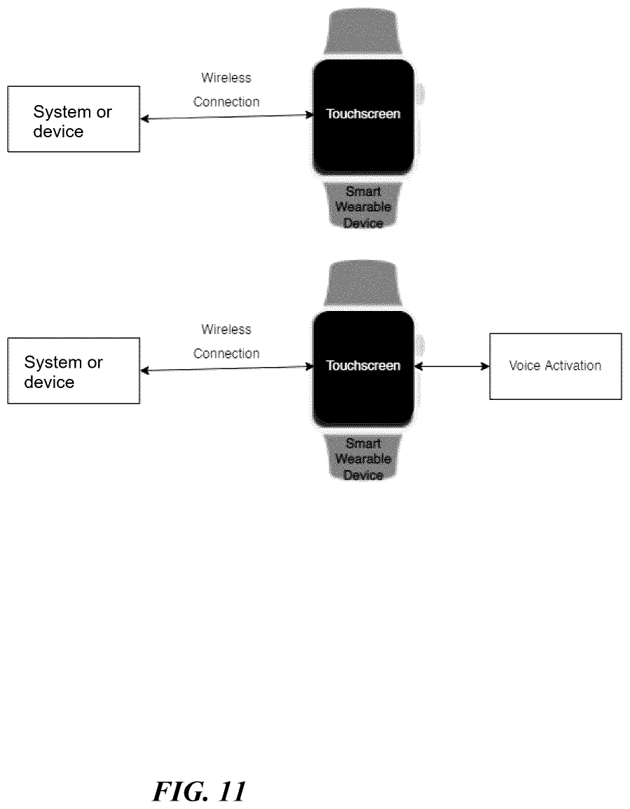

FIG. 11 depicts another example of functional block diagrams of a system or apparatus that facilitates nail polish making, in accordance with embodiments of the present disclosure.

The system or apparatus can be connected to a portable electronic device (e.g., a smart device, a smart watch, or any other smart wearable) via wireless connections. The portable electronic device can, for example, control the system through voice command.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the innovative subject matter has been described with reference to specific example embodiments, various modifications and changes may be made to these embodiments without departing from the broader scope of embodiments of the present disclosure. Such embodiments of the novel subject matter may be referred to herein, individually or collectively, by the term “innovation” merely for convenience and without intending to voluntarily limit the scope of this application to any single disclosure or novel or innovative concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will begin with the words “means for”.) Accordingly, the applicant reserves the right to add additional claims after filing the application to pursue such additional claim forms for other aspects of the disclosure.

What is claimed is:

1. An apparatus to make nail polish from one or more ink colors, comprising:
a housing unit;
an ink retention unit configured to hold or store one or more ink storage containers;
wherein, the one or more ink storage containers store each of the one or more ink colors separately;
an ink deposit component disposed in the housing unit, the ink deposit component being mechanically coupled to the ink retention unit;
wherein, the ink deposit component includes an actuator to control or regulate ink that is released from the ink retention unit;
a nail polish holder area under the ink deposit component configured to receive the ink released from the ink deposit component.

2. The apparatus of claim 1, further comprising,
a power component formed in the housing unit;
a display coupled to the power component;
wherein the display is integrated into the housing unit and formed on a visible surface of the housing unit.

3. The apparatus of claim 2, wherein,
wherein the display includes a touch screen.

4. The apparatus of claim 1,
wherein, the ink retention component is formed in the housing unit;
wherein, the one or more ink storage containers has formed thereon, an opening for refill of its contents;
further wherein, the one or more ink storage containers are attached to the ink retention component and irremovable.

5. The apparatus of claim 1, wherein:
the housing unit includes a hinge system;
further wherein, the hinge system mechanically couples the one or more ink storage containers to the housing unit;
wherein, the hinge system is operable by rotation to access the one or more ink storage containers for refill or removal.

6. The apparatus of claim 1, wherein:
the one or more ink storage containers are rotated onto or screwed into the ink retention unit.

7. The apparatus of claim 1, wherein:
the actuator of the ink deposit component includes a peristaltic pump system.

8. The apparatus of claim 1, wherein:
the actuator includes a peristaltic pump system having multiple peristaltic pumps each mechanically coupled to and to control each of the one or more ink storage containers.

9. The apparatus of claim 8, further comprising:
one or more motors mechanically coupled to the peristaltic pump system;
wherein the one or more motors are operable to rotate each of the multiple peristaltic pumps.

10. The apparatus of claim 1, wherein:
the ink deposit component includes a funnel adapted to direct ink flow to the nail polish holder area.

11. The apparatus of claim 1, further comprising:
a nail polish holder device arranged to hold or receive a nail polish bottle to receive and store the ink released to the nail polish holder area.

12. The apparatus of claim 11, wherein:
the nail polish holder device is mechanically coupled to the housing unit in a mixing area;
wherein, the nail polish holder device is configured to tilt the nail polish bottle.

13. The apparatus of claim 12, wherein:
the nail polish holder device is mechanically coupled to the mixing area through a motor operable to rotate the nail polish holder device.

14. The apparatus of claim 11, wherein:
the nail polish holder device comprises a spring clamp to hold the nail polish bottle in a tilted position.

15. The apparatus of claim 12, wherein:
the nail polish holder device is mechanically coupled to the mixing area through a ball joint;
wherein, the ball joint enables tilting of the nail polish holder device and the nail polish bottle.

16. The apparatus of claim 12, wherein:
the mixing area forms a portion of the housing unit and is co-located with the portion of the housing unit having the nail polish holder area.

17. The apparatus of claim 12, wherein:
the mixing area forms a second portion of the housing unit;
wherein the second portion of the housing unit is distinct from the portion of the portion of the housing unit having the nail polish holder area.

18. The apparatus of claim 12, wherein:
the mixing area is a physical component distinct from the housing unit and the nail polish holder area of the housing unit;
wherein, the mixing area is operably coupled to the housing unit via a connection unit.

19. The apparatus of claim 1, further comprising:
a processor;
a memory unit coupled to the processor, the memory unit having stored thereon instructions which when executed by the processor, causes the processor to:
receive a request create or make the nail polish;
activate the ink deposit component to release the ink to flow to the nail polish holder area.

20. A system to make nail polish of a given color, the system, comprising:
a network interface;
a processor coupled to the network interface;
a memory unit coupled to the processor, the memory unit having stored thereon instructions which when executed by the processor, causes the processor to:
receive a request create or make the nail polish of the given color;
release and regulate ink flow from one or more ink storage containers to a nail polish holder area;
wherein, regulation of amount of the ink flow from the one or more storage containers is determined based on the given color;
activate a motor to rotate the nail polish holder area to mix the ink flow received from the one or more storage containers to create the nail polish of the given color.
